(19) United States
(12) Patent Application Publication
(10) Pub. No.: US 2008/0223413 A1
(43) Pub. Date: Sep. 18, 2008

(54) Color changing soap

(76) Inventor: Philip T. Radford, Roebuck, SC (US)

Correspondence Address: Legal Department (M-495), P.O. Box 1926, Spartanburg, SC, 29304, US

(21) Appl. No.: 11/717,873

(22) Filed: Mar. 14, 2007

(51) Int. Cl. B08B 3/04; B67D 5/40

(52) U.S. Cl. 134/34; 222/383.1

(57) ABSTRACT

A color changing soap dispenser having a reservoir and a pump. The reservoir contains a color changing soap. The color changing soap contains a soap composition comprising water and a surfactant, an indicator dye which exhibits an observable color change at a color change pH, and a base selected from the group consisting of carbonate salts of group I and II elements, phosphate salts of group I and II elements, bicarbonate salts of group I and II elements, and hydroxide salts of group I and II elements. The color changing soap has a pH of greater than 7 and less than 13. The method of using the color changing soap is also disclosed.

### TECHNICAL FIELD

The present invention generally relates to soap for hand, body, and surface washing. More particularly, the invention relates to soap with a color indicating material that can be used to indicate the length of time of washing.

### BACKGROUND

Soap and water are effective cleaners for some applications and can be effective in fighting bacteria and other causes of illness. In many cases, effective cleaning and disease control occur only after certain periods of time or at elevated temperatures. While it may be a relatively simple matter for adults to judge the appropriate time for washing, this is not always the case with children. Children, whether in brushing teeth or washing hands, for example, tend to spend less time on the task than desired by parents and other caregivers. This can result in ineffective cleaning.

It is, therefore, quite important for children to learn the correct way of completing a key hygiene task such as brushing teeth or washing hands. In order for these habits to form at an early age, parents or guardians typically rely on constant reminders and close monitoring. It takes a lot of time and attention from the parent or the guardian in their attempts to build and reinforce these hygiene habits. Further, children tend to follow the instructions only as long as they feel they are being monitored. Most often, children grow up learning these habits only as a result of pressure from their parents or guardians, and do not maintain these habits once the pressure of close monitoring is absent.

An important aspect of building these hygiene habits is to involve the children in completing the task in a way that focuses their attention on the hygiene activity in a non-threatening and natural manner. One way of accomplishing this would be to introduce an element of fun and play so that children enjoy completing the task while building these habits. Another way would be to give them a sense of accomplishment by providing a feedback signal they can easily understand and associate with correctly completing the task. If there is an element of fun and play in addition to a clear feedback indication, children are likely to complete the hygiene task without any need for close supervision and monitoring by their parents and guardians.

Thus, there is a need to have a soap product that will give an indication of when sufficient use has occurred and be enjoyable and instructive for children in teaching the proper amount of time for washing.

### SUMMARY

The present invention provides advantages and/or alternatives over the prior art by providing a color changing soap dispenser having a reservoir and a pump, the reservoir having a color changing soap. The color changing soap contains soap composition comprising water and a surfactant, an indicator dye which exhibits an observable color change at a color change pH, and a base selected from the group consisting of carbonate salts of group I and II elements, phosphate salts of group I and II elements, bicarbonate salts of group I and II elements, and hydroxide salts of group I and II elements. The color changing soap has a pH of greater than 7 and less than 13. The method of using the color changing soap is also disclosed.

### BRIEF DESCRIPTION OF THE DRAWINGS

The present invention will now be described by way of example only, with reference to the accompanying drawings which constitute a part of the specification herein and in which:

FIG. 1 is an illustration of the color changing soap dispenser with the reservoir and pump.

FIG. 2 is an illustration of a magnified cross-sectional view of the pump which is a foam generating pump.

### DETAILED DESCRIPTION

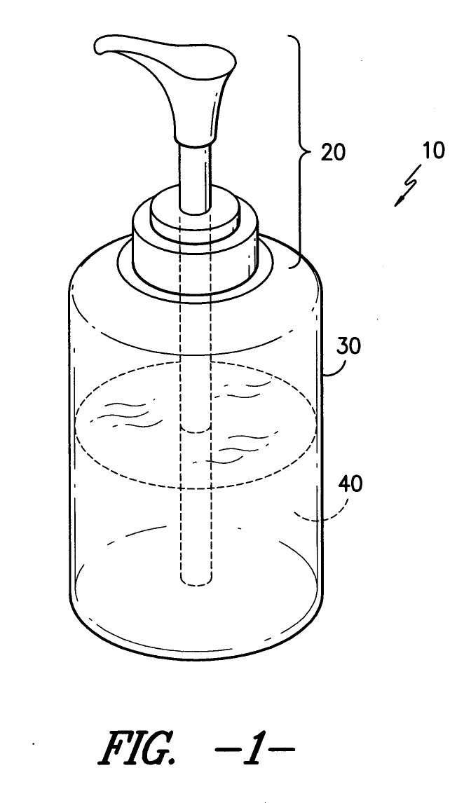

Referring now to FIG. 1, there is a shown a color changing soap dispenser 10 having a pump 20 and a reservoir 30 containing color changing soap 40. The pump 20 has a check-valve and spring arrangement (not shown) which allows the one-way movement of the color changing soap 40 through the pump 20. When a user pushes down on the pump 20, the pump is actuated, moving the color changing soap 40 upwardly from the reservoir 30, through pump assembly 20 and discharging it.

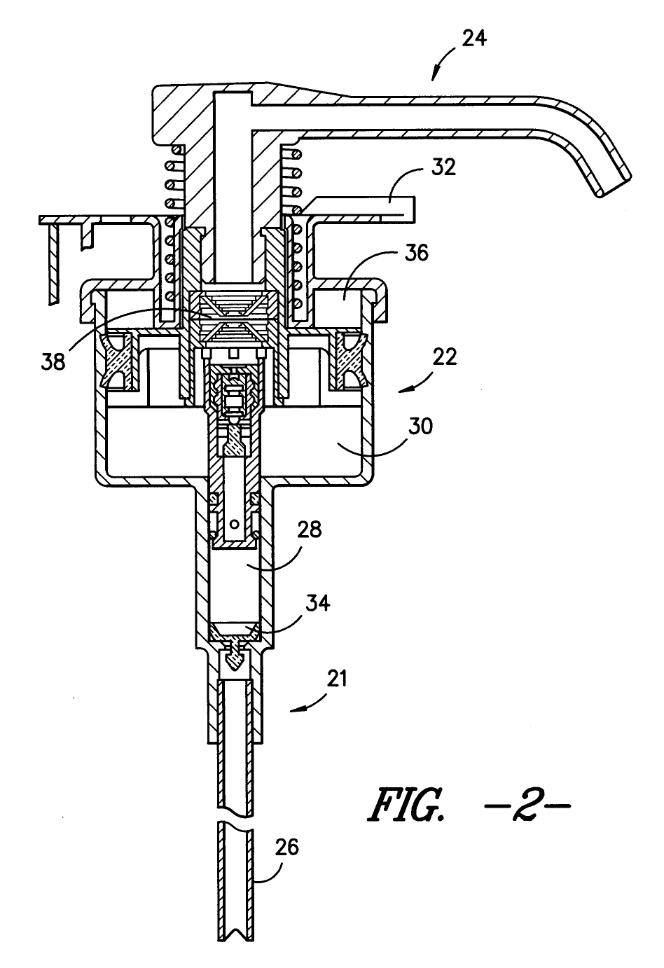

FIG. 2 shows a magnified cross-sectional view of one embodiment of a pump being a foam generating pump 20. It is preferable to have the soap dispensed in a foamed state because it is easier for children to use and produces good cleaning results. Another example of a foam generating pump may be found in U.S. Pat. No. 6,446,840, incorporated herein by reference. The foam generating pump 20 has a lower intake member 21, a central pump assembly 22, and an upper outlet member 24. The intake member 21 has an open intake tube 26 extending into the soap during normal operation, and connected to a lower extension 28 forming a liquid chamber 30 projecting from a housing 32. A check-valve 34 permits flow only up into the chamber 30 from the tube 26. The central pump assembly 22 has a foam-generating nozzle which, when pressurized with a liquid on one side emits on the opposite side a swirling aerosol spray. Axial passages and radial ports allow air flow from the chamber 36 into the chamber 38. The foaming chamber 38 holds a foam generator. The housing 32 is designed to sit on the rim of the reservoir 30.

The reservoir 30 of the color changing soap dispenser contains color changing soap 40. The color changing soap is a single phase, unlike some dual phase compositions that have components that must stay separated (through dual chambers or the like) until use. A dual chamber system increases the packaging cost by requiring two reservoirs and two pumps. A dual system requires accurate mixing at the correct ratio in order to deliver the maximum level of effectiveness. When the ratio control malfunctions it results one component running out before the other component, leading to the disposal of a perfectly good component because the partner solution is empty. The color changing soap 40 of the invention exhibits an observable color change after the soap has been applied to the skin for a period of time. Changes in color may be from colorless to colored, colored to colorless, or from one color to another.

The color changing soap 40 contains a soap composition comprising at least water and a surfactant, an indicator dye which exhibits an observable color change at a color change pH, and a base selected from carbonate salts of group I and II elements, phosphate salts of group I and II elements, bicarbonate salts of group I and II elements, and hydroxide salts of group I and II elements. The color changing soap has a pH of greater than 7, but less than 13. More preferably, the color changing soap has a pH of between 9 and 10.5. Most classic soaps in their natural form are basic and are only neutralized with an acid. Soap manufactures have found that basic soaps are often more effective at cleaning than the acid alternatives. The color changing system works with all of the following commercially available soap compositions:

GermBlaster™ commercially available from GermX™ and contains water, cetrimonium chloride, lauramide dea, glycerin, DI-PPG-2,myreth-10 adipate, DMDM hydantoin, fragrance, polyquaternium-92, dipropylene Glycol, Citric acid, tetrasodium EDTA, benzophenenone-4, orange 4, and Red 4.

Softsoap™ commercially available from Colgate Palmolive™ and contains water, sodium laureth sulfate, cocamidopropyl betaine, decyl glucoside, fragrance, DMDM hydantoin, PEG-120 methyl glucose dioleate, tetra sodium EDTA, sodium sulfate, citric acid, Peg-7 glyceryl cocoate, Benzophenone 4, FD&C Blue 1, and D&C red 33.

Tone Exotic Fusion™ commercially available from Dial and contains water, sodium laureth sulfate, cocamidopropyl betaine, glycerin, decyl glucoside, disodium cocoyl glutamate, PEG-8, PEG-18 glyceryl oleate/cocoate, PEG2hydroxyethyl coco/isostearate, PEG 60 almond glycerides, and many exotic scents and colors.

Tone Island Muse™ commercially available from Dial and contains water, glycerin, sodium laureth sulfate, cocamidopropyl betaine, decyl glucoside, PEG-8, PEG-18 glyceryl oleate/cocoate, and many exotic scents and colors

The surfactant may be selected from catonic, anionic, amphoteric, ampholytic, nonionic surfactants, and mixtures thereof. In one embodiment, the surfactant is normally in the range of 0.1-10% by weight, preferably 4-7% by weight, based on the total weight of the color changing soap. Specific cationic surfactants that can be used in the soap composition include, but are not limited to, lauryl sulfates, octyl sulfates, 2-ethylhexyl sulfates, lauramine oxide, decyl sulfates, tridecyl sulfates, cocoates, lauryl sarcosinates, lauryl sulfosuccinates, linear C₁₀ diphenyl oxide disulfonates, lauryl sulfosuccinates, lauryl ether sulfates (1 and 2 moles ethylene oxide), myristyl sulfates, oleates, stearates, tallates, cocamine oxide, decylamine oxide, myristamine oxide, ricinoleates, cetyl sulfates, and similar surfactants.

Alternative surfactants suitable for use with the present invention include, anionic surfactants such as sodium alkyl sulphate. By “alkyl sulphate” it is meant herein the water-soluble salts of alkyl sulphates having from 8 to 20 carbon atoms in the alkyl radical, including sodium lauryl sulphate. Further anionic surfactants useful herein include the potasium alkyl sulphates having from 8 to 20 carbon atoms in the alkyl radical (e.g., sodium alkyl sulphate), sulphoacetates, alkyl glyceryl sulphonates and the sarcosinates. Non-limiting examples of the anionic surfactants of this type which are suitable for the present invention are sodium decyl sulphate, sodium lauryl sulphosuccinate, sodium lauryl sulphate and sodium lauroyl sarcosinate. Anionic surfactants can be used at levels as low as about 0.0001% or up to about 25% by weight of the composition. Highly preferred levels of anionic surfactant, and especially of sodium alkyl sulphate, are from about 0.7 to about 3%, preferably from about 1% to about 2% by weight. Additional suitable anionic surfactants include, but are not limited to, compounds in the classes known as alkyl ether sulfates, alkyl ether sulfonates, sulfate esters of an alkylphenoxy polyoxyethylene ethanol, alpha-olefin sulfonates, beta-alkoxy alkane sulfonates, alkylaryl sulfonates, alkyl monoglyceride sulfates, alkyl monoglyceride sulfonates, alkyl carbonates, alkyl ether carboxylates, fatty acids, sulfosuccinates, sarcosinates, octoxynol or nonoxynol phosphates, taurates, fatty taurides, fatty acid amide polyoxylethelyne sulfates, isethionates, or mixtures thereof.

The surfactant used may also be a nonionic surfactant, including cocomide diethanolamine (cocomide DEA) and substituted polyethylene glycol ethers selected from PEG-32 glyceryl stearate and PEG-40 sorbitan di-isostearate.

An alternative cleaning agent useful with the present invention includes cocomidopropyl betaine, which is an amphoteric surfactant. Amphoteric surfactants useful in the present invention can be broadly described as derivatives of aliphatic secondary and tertiary amines in which the aliphatic radical can be a straight chain or branched and wherein one of the aliphatic substituents contains from about 8 to about 18 carbon atoms and one contains an anionic water-solubilizing group (e.g., carboxylate, sulfonate, sulphate, phosphate or phosphonate). Other suitable amphoteric surfactants are betaines, specifically cocamidopropyl betaine. Mixtures of amphoteric surfactants or mixtures of amphoteric and anionic surfactants may also be employed.

The indicator dye of the color changing soap exhibits an observable color change at a color change pH (appropriate change in the pH of the soap). Preferably, the indicator dye exhibits a color change pH of about 7 to 13, more preferably about 8 to 9. Suitable pH sensitive dyes include but are not limited to (CAS numbers are in parentheses): alizarin complexone 2 hydrate (3952-78-1), bromochlorophenol blue sodium salt (102185-52-4), bromcresol green free acid (76-60-8), bromcresol green sodium salt (62625-32-5), bromocresol purple free acid (115-40-2), bromocresol purple sodium salt (62625-30-3), bromophenol blue free acid (115-39-9), bromophenol blue sodium salt (62625-28-9), bromopyrogallol red (16574-43-9), bromothymol blue free acid (76-59-5), bromothymol blue sodium salt (34722-90-2), bromophenol red free acid (2800-80-8), bromophenol red sodium salt (102185-50-2), bromoxylenol blue (40070-59-5), calconcarboxylic acid (3737-95-9), calmagite (3147-14-6), chlorophenol red (4430-20-0), o-cresolphthalein (596-27-0), o-cresolphthalein complexone (2411-89-4), o-cresolphthalein complexone sodium salt (94442-10-1), meta-cresol purple (2303-01-7), meta-cresol purple w/s (62625-31-4), cresol red free acid (1733-12-6), cresol red sodium salt (62625-29-0), eriochrome blue black R (2538-85-4), ethyl orange sodium salt (62758-12-7), ethyl red indicator (76058-33-8), fast sulphon black F (3682-47-1), fluorexon/calcein (1461-15-0), iodine indicator (9005-84-9), litmus (1393-92-6), methyl orange (547-58-0), methyl red free acid (493-52-7), methyl red HCl (63451-28-5), methyl red sodium salt (845-10-3), methylthymol blue w/s (1945-77-3), murexide powder (3051-09-0), naphtholbenzein (145-50-6), a-naphtholphthalein (596-01-0), 3-nitrophenol,99% (554-84-7), 1-(2-pyridylazo)-2-naphthol (85-85-8), P.A.R. free acid (1141-59-9), P.A.R. monosodium (16593-81-0), patent blue VF (129-17-9), phenol red free acid (143-74-8), phenol red sodium salt (34487-61-1), phenolphthalein white /USP (77-09-8), 4-(phenylazo)diphenylamine (101-75-7), pyrocatechol Violet (115-41-3), pyrogallol (87-66-1), quinaldine red (117-92-0), SPADNS (23647-14-5), thorin I (3688-92-4), thymol blue free acid (76-61-9), thymol blue sodium salt (62625-21-2), thymolphthalein (125-20-2), thymolphthalein complexone (1913-93-5), tropaeolin O (547-57-9), xylenol blue (125-31-5), xylenol orange tetrasodium salt (3618-43-7), and the like. Preferably, the indicator dye is (color change pH range in parenthesis): brilliant yellow (yellow to orange, 6.6-8.0), phenol red (yellow to red, 6.8-8.2), neutral red (red to colorless, 6.8-8.0), m-nitrophenol (colorless to yellow, 6.8-8.6), cresol red (yellow to red, 7.0-8.8), curcumin (yellow to red, 7.4-8.6), meta cresol purple (yellow to purple, 7.4-9.0), thymol blue (yellow to blue, 8.0-9.2), phenolphthalein (colorless to red, 8.0-10.0), o-cresolphthalein (colorless to red, 8.2-9.8), p-naphtholbenzein (colorless to blue, 8.2-10.0), thymolphthalein (colorless to blue, 8.8-10.5), nile blue A (blue to red, 9.4-10.6), alizarin yellow R (yellow to red, 10.0-12.0), curcumin (red to orange, 10.2-11.8), and alizarin (red to purple, 7.2-12.4).

In one embodiment, the indicator dye is phenolphthalein and in another embodiment, the indicator dye is thymol blue. It has been found that these two dyes produce vivid, dark colors in reasonable concentrations in the color changing soap, colored bubbles in foam produced by the dispenser, and a change in coloration in a reasonable amount of time when applied to skin. While the thymol blue was in solution the color is an intensely dark color similar to black ink, but upon foaming this dark solution turns to a brilliant, bright red-purple color. Preferably, the indicator dye is washable, meaning that the dye is removed from clothing and other textiles after washing in a standard residential laundering cycle.

Preferably, the color changing soap has a pH of no more than 2 pH units greater than the color change pH of the indicator dye, more preferably 1 pH unit. In another embodiment, when the soap becomes more basic in use, the indicator dye lightens in color. In one embodiment, the indicator dye has a chroma of less than 10, preferably less than 5, when the pH is less than the color change pH. The chroma was measured by placing foam on a white textile fabric and recording the color value using a spherically reflected colorimeter manufactured by Hunter laboratory. This means that when applied to the skin from the dispenser, the color changing soap has a bright coloration (chroma of greater than 15). Once the product is manipulated in the hands for a certain time, the indicator dye becomes much less colored, becoming lighter, close to colorless, or colorless to indicate that the appropriate time for washing has elapsed. This system has the advantage that if the product were to get on one's clothing, the dye would fade and become very light or colorless over time and so as to not form an unsightly washable stain on the clothing.

The amount of dye used in the practice of the invention typically is between about 0.001 and 0.5 weight percent, more desirably between about 0.002 and 0.3 weight percent dye and still more desirably between about 0.005 and 0.2 weight percent.

The base used in the color changing soap is selected from carbonate salts of group I and II elements, phosphate salts of group I and II elements, bicarbonate salts of group I and II elements, and hydroxide salts of group I and II elements. Preferred bases include sodium bicarbonate, sodium carbonate, sodium phosphates, sodium hydroxide, calcium hydroxide, and potassium hydroxide. These bases are preferred because they are well suited for use in personal care products. Bases such as ammonia and ammonium bases are not preferred because of their objectionable odor and/or possible skin irritation. Ammonia has been removed from several hard surface cleaners due to these issues and others. The base is preferably nonvolatile and the color change does not rely on the base evaporating from the foam produced upon dispensing the color changing soap.

In one embodiment, the color changing soap includes a pH buffer. Buffering the pH is commonly used in chemical reactions to control the rate of reaction. In the case of the invention, a pH buffer may be used for this purpose as well as to increase the stability of the mixture in storage and transportation. Suitable pH buffers include but are not limited to sodium laureth sulfate and citric acid, and so forth. Selection of one or more buffering agents, however, would be dependent upon the color changing soap composition and are within the ability of those skilled in the art to select.

In one embodiment, the color changing soap contains an antimicrobial agent. Preferred antimicrobial agents include iodine, iodophors, chlorhexidine salts such as chlorhexidine gluconate, and triclosan. A preferred silver-based ion exchange material is an antimicrobial silver zirconium phosphate available from Milliken & Company, under the trade name AlphaSan®. Other potentially preferred silver-containing solid inorganic antimicrobials in this invention are silver-substituted zeolite available from Sinanen under the tradename ZEOMIC™, silver-substituted glass available from Ishizuka Glass under the tradename IONPURE, silver-based materials such as MICROFREE™, available from DuPont, as well as JMAC™, available from Johnson Mathey.

The soap composition may also include oils, detergents, emulsifiers, film formers, waxes, perfumes, preservatives, emollients, solvents, thickeners, humectants, chelating agents, stabilizers, vitamins, pH adjusters, and so forth. Humectants may comprise about 0.1 to 5 weight % of the soap while preservatives may comprise about 0.1 to 1.0 weight % of the soap. Suitable humectants include glycerin and suitable preservatives include DMDM hydantoin and other like materials. Vitamins, such as vitamin E acetate and vitamin A palmitate, for example, may be present in the soap in an amount of about 0.1 to 1.0 weight %, and preferably in an amount of about 0.01 to 0.5 weight %.

The color changing soap may also include other conventional additives such as antioxidants, neutralizers, colorants, and fragrances. The amounts of such additives will be dependent upon the soap end product. Consumer acceptable amounts of dyes and fragrances may also be added in sufficient amounts to perform their intended function without adversely affecting the stability and color changing nature of the color changing soap.

The method for washing with a color changing soap comprises dispensing a color changing soap from a color changing soap dispenser onto skin in a foamed state. The color changing soap dispenser has a reservoir and a pump and the reservoir contains the color changing soap. The color changing soap includes a soap composition having water and a surfactant, an indicator dye which exhibits an observable color change at a color change pH, and a base selected from the group consisting of carbonate salts of group I and II elements, phosphate salts of group I and II elements, bicarbonate salts of group I and II elements, and hydroxide salts of group I and II elements. The color changing soap has a pH of greater than 7 and less than 13. Next, the colored soap (which may be foamed) is manipulated on the skin until the indicator dye changes color and then rinsed off the skin with water.

The detectible change in coloration of the indicator dye may occur in at most about 5 minutes after dispensing, though the change generally does not occur until a second or more after dispensing. The change may occur in at between about 1 second and about 120 seconds, or more desirably between about 5 seconds and about 45 seconds, or still more desirably between about 15 and 35 seconds. The color change may occur in about 10 seconds.

The amount of time between dispensing and color change will depend on the formulation used as well as how clean the skin is. It has been found that in repeated consecutive skin washings with the soap, the indicator dye takes longer to change color in subsequent washings. While not being bound by any theory, it is believed that the oil, dirt, and other substances on the skin produce the change in pH from basic to less basic causing the color change.

A series of experiments were conducted to verify this theory. A long narrow plastic bag was collapsed completely and then filled with nitrogen. The nitrogen lines were left on such that a nitrogen purge was created in the bag. A hand was placed in the bag and color changing soap was introduced through a small hole. The soap was placed on the palm and the fingers slowly opened and closed inside the nitrogen purged bag. The color of the foam produced was initially pink (phenolphthalein) coming from the foam dispenser but gradually turned to a white foam in approximately 10 seconds. The experiment was triplicated with similar results. This result suggests that neither CO₂ nor O₂ are the primarily responsible for the reaction that causes the color change of the soap during use.

Two solutions containing the exact same pink dye concentration were made. One was formed using ammonia as a base and the other with sodium hydroxide as a base. Both solutions had a pH of 10. Both solutions were foamed onto a rubber automotive tire. They both came out of a foaming dispensor an intense red (phenolphthalein). Within 15 seconds the ammonia containing solution was colorless. Pink could be detected in the NaOH titrated foam for at least 8 minutes. At the 8 minute point both foams began to collapse making it difficult to detect the color on a black tire. The mechanism by which the ammonia containing soap changes color is different than the mechanism by which the foam titrated by NaOH changes color. It is believed that the ammonia based solution changed pH when the ammonia compound evaporated into the air.

Samples of the color changing soap made with NaOH and phenolphthalein were placed on the hand and on a Formica (non reactive) surface. The same amount of agitation was applied to the soaps. The color changing soap on the skin changed color in approximately 10 seconds whereas the color changing soap on the Formica surface changed well after five minutes and longer.

Vigorous hand rubbing may also decrease the time for the indicator dye to change color as compared to slow hand rubbing. Reducing the amounts of dye and other components will likewise result in lengthening the time to the color change. Relatively simple experimentation with the amounts and types of soap, dye and other components discussed herein allows one to design a color change composition that will change color in a length of time up to about 5 minutes.

### EXAMPLES

Example 1 was formed from a mixture of 200 grams of a Dial Complete™ foaming handwash (containing water, sodium xylenesulfonate, dipropylene glycol, cocamidopropyl betaine, disodium phosphate), 0.2 grams phenolphthalein, and approximately 2 mL of ammonium hydroxide. After the addition of the base the pH of the solution was 9.5. The resulting solution was a black liquid and opaque but when foamed through a foaming soap dispenser the color was significantly different as a bright red purple and colored. The soap was placed in a reservoir of a foaming soap dispenser. When a full pump (approx 1.5 mL of material) was dispensed of purple colored foam it gradually faded to a white foam color. The volatile base ammonia gradually flashes off the foam causing the pH to become more neutral and the indicator dye to appear colorless in approximately 6 seconds.

When the experiment was conducted at a sink (outside a hood) a strong smell of ammonia was detected. Placing hands near to the nose and smelling greatly intensified the smell. Though the color did change as the hands were scrubbed the ammonia smell may have been considered too intense and objectionable for a consumer product.

Example 2 was formed by mixing 1.45 liters of Dial Complete™ foaming handwash with 3 grams phenolphthalein and approximately 10 mL of sodium hydroxide in a 2 L beaker with a stir rod. After the addition of the base the pH of the soap was 10. The resulting solution was a deep purple black and opaque but when foamed through a foaming soap dispenser the color was significantly brighter and colored a mid-range, bright purple. The soap was placed in a reservoir of a foaming soap dispenser. When a full pump (approx 1.5 mL of material) was dispensed of purple colored foam it gradually faded to a white or colorless foam. When used for hand washing, scrubbing the hands accelerated the color change. It took approximately 8 seconds for the color to change.

Example 3 was formed by mixing 1.45 liters of Dial Complete™ foaming handwash with 1.4 grams of thymol blue and approximately 10 mL of sodium hydroxide in a 2 L beaker with a stir rod. After the addition of the base the pH of the soap was 9.8. The resulting solution was a deep blue black color and opaque but when foamed through a foaming soap dispenser the color was a classic bright, mid-range blue. The soap was placed in a reservoir of a foaming soap dispenser. When a full pump (approx 1.5 mL of material) was dispensed of blue colored foam it gradually faded to a tan color. When used for hand washing, scrubbing the hands accelerated the color change to approximately 10 seconds. The tan shade is noticeable on a white paper towel but is not as apparent on the hands when scrubbed.

Examples 2 and 3 illustrate the color changing soap of the invention that will give an indication of when sufficient use has occurred with no objectionable odors.

While the present invention has been illustrated and described in relation to certain potentially preferred embodiments and practices, it is to be understood that the illustrated and described embodiments and practices are illustrative only and that the present invention is in no event to be limited thereto. Rather, it is fully contemplated that modifications and variations to the present invention will no doubt occur to those of skill in the art upon reading the above description and/or through practice of the invention. It is therefore intended that the present invention shall extend to all such modifications and variations as may incorporate the broad aspects of the present invention within the full spirit and scope of the invention.

What is claimed is:

1. A color changing soap dispenser comprising:
a reservoir and a pump;
the reservoir comprising a color changing soap, the color changing soap comprising;
a soap composition comprising water and a surfactant, an indicator dye which exhibits an observable color change at a color change pH, and a base selected from the group consisting of carbonate salts of group I and II elements, phosphate salts of group I and II elements, bicarbonate salts of group I and II elements, and hydroxide salts of group I and II elements, wherein the color changing soap has a pH of greater than 7 and less than 13.

2. The color changing soap dispenser of claim 1, wherein the base is selected from the group consisting of sodium bicarbonate, sodium phosphates, sodium hydroxide, calcium hydroxide, and potassium hydroxide.

3. The color changing soap dispenser of claim 1, wherein the surfactant is selected from the group consisting of cationic, anionic, amphoteric, ampholytic, nonionic surfactants, and mixtures thereof.

4. The color changing soap dispenser of claim 1, wherein the indicator dye is selected from the group consisting of phenolphthalein and thymol blue.

5. The color changing soap dispenser of claim 1, wherein the color changing soap has a pH of between 9 and 10.5.

6. The color changing soap dispenser of claim 4, wherein the indicator dye has a color change pH of between 8 and 9.

7. The color changing soap dispenser of claim 1, wherein the color changing soap further comprises an antimicrobial compound.

8. The color changing soap dispenser of claim 1, wherein the indicator dye has a chroma of less than 10 at a pH less than the color change pH.

9. The color changing soap dispenser of claim 1, wherein the base is non-volatile.

10. The color changing soap dispenser of claim 1, wherein the color changing soap has a pH of no more than 2 pH units greater than the color change pH.

11. The color changing soap dispenser of claim 1, wherein the pump is a foam generating pump.

12. A method of washing with a color changing soap comprising:
dispensing a color changing soap from a color changing soap dispenser onto skin, the color changing soap dispenser comprising a reservoir and a pump, wherein the reservoir comprising a color changing soap, the color changing soap comprising a soap composition comprising water and a surfactant, an indicator dye which exhibits an observable color change at a color change pH, and a base selected from the group consisting of carbonate salts of group I and II elements, phosphate salts of group I and II elements, bicarbonate salts of group I and II elements, and hydroxide salts of group I and II elements, wherein the color changing soap has a pH of greater than 7 and less than 13;
manipulating the soap onto the skin until the indicator dye changes color; and,
rinsing the skin with water until the color changing soap is removed from the skin.

13. The method of claim 12, wherein the base is selected from the group consisting of sodium bicarbonate, sodium phosphates, sodium hydroxide, calcium hydroxide, and potassium hydroxide.

14. The method of claim 12, wherein the indicator dye changes color in less than 120 seconds.

15. The method of claim 12, wherein the indicator dye changes color in between 5 and 35 seconds.

16. The method of claim 12, wherein the indicator dye is selected from the group consisting of phenolphthalein and thymol blue.

17. The method of claim 16, wherein the indicator dye has a color change pH of between 8 and 9.

18. The method of claim 12, wherein the indicator dye has a chroma of less than 10 when the pH of the color changing soap is less than the color change pH.

19. The method of claim 12, wherein the color changing soap has a pH of no more than 2 pH units greater than the color change pH.

20. The method of claim 12, wherein the color changing soap is dispensed onto skin in a foamed state.
